(19) United States
(12) Patent Application Publication
(10) Pub. No.: US 2025/0200647 A1
(43) Pub. Date: Jun. 19, 2025

(54) GOODS DISPLAY ASSISTANCE SYSTEM, GOODS DISPLAY ASSISTANCE METHOD, AND RECORDING MEDIUM

(71) Applicant: NEC Corporation, Minato-ku, Tokyo (JP)

(72) Inventors: Yuki TSURUOKA, Tokyo (JP); Takashi MIYAKE, Tokyo (JP); Yushi NIWA, Tokyo (JP); Akihiko ONITA, Tokyo (JP)

(73) Assignee: NEC Corporation, Minato-ku, Tokyo (JP)

(21) Appl. No.: 18/836,112

(22) PCT Filed: Feb. 16, 2022
(86) PCT No.: PCT/JP2022/006118

§ 371 Date: Aug. 6, 2024

(51) Int. Cl. G06Q 30/0601; G06F 3/01; G06T 11/00

(52) U.S. Cl. CPC G06Q 30/0643; G06F 3/013; G06T 11/00

(57) ABSTRACT

A goods display assistance system comprising: at least one memory storing instructions; and at least one processor configured to execute the instructions to: display a predetermined goods display in a store in a virtual space on a head mounted display worn by a user; detect a movement of a line of sight of the user; and determine a new goods display based on the detected movement of the line of sight.

### TECHNICAL FIELD

The present disclosure relates to a goods display assistance system and the like.

### BACKGROUND ART

There is a technique of analyzing a line of sight or the like of a customer using an imaging device installed in a store. For example, there is a case where an analysis result is used for displaying a product.

There is a technology of detecting a line of sight by a head mounted display. For example, PTL 1 describes a technique for changing a position and a posture of an object to which a person pays attention by a line of sight of the person wearing a head mounted display in an augmented reality (AR) space.

### CITATION LIST

### Patent Literature

PTL 1: JP 2017-68851 A

### SUMMARY OF INVENTION

### Technical Problem

It may be difficult to determine the goods display in a store.

An object of the present disclosure is to provide a goods display assistance system or the like that facilitates goods display determination.

### Solution to Problem

A goods display assistance system according to an aspect of the present disclosure includes a first output control means for displaying a predetermined goods display in a store in a virtual space on a head mounted display worn by a user, a detection means for detecting a movement of a line of sight of the user, and a determination means for determining a new goods display based on the detected movement of the line of sight.

A goods display assistance method according to an aspect of the present disclosure includes displaying a predetermined goods display in a store in a virtual space on a head mounted display worn by a user, detecting a movement of a line of sight of the user, and determining a new goods display based on the detected movement of the line of sight.

A program according to an aspect of the present disclosure causes a computer to execute the processes of displaying a predetermined goods display in a store in a virtual space on a head mounted display worn by a user, detecting a movement of a line of sight of the user, and determining a new goods display based on the detected movement of the line of sight.

The program may be stored in a non-transitory computer-readable recording medium.

### Advantageous Effects of Invention

According to the present disclosure, it is possible to facilitate determination of the goods display.

### BRIEF DESCRIPTION OF DRAWINGS

FIG. 1 is a block diagram illustrating a configuration example of a goods display assistance system according to the first example embodiment.

FIG. 2 is a flowchart illustrating an operation example of the goods display assistance system according to the first example embodiment.

FIG. 3 is an explanatory diagram illustrating an example of a real space and a virtual space.

FIG. 4 is an explanatory diagram illustrating an example of connection between a goods display assistance system and an HMD.

FIG. 5 is a block diagram illustrating a configuration example of a goods display assistance system according to the second example embodiment.

FIG. 6 is a flowchart illustrating an example in which the goods display is repeatedly displayed to the same customer by the goods display assistance system according to the second example embodiment.

FIG. 7 is an explanatory diagram illustrating Example 1 in which a product attracting attention is moved to an easily seen position.

FIG. 8 is an explanatory diagram illustrating Example 2 in which a product attracting attention is moved to an easily seen position.

FIG. 9 is an explanatory diagram illustrating a goods display example in which a product to be purchased together with the product attracting attention is disposed next to the product attracting attention.

FIG. 10 is an explanatory diagram illustrating an example in which product scores are output in order of product scores.

FIG. 11 is a flowchart illustrating an operation example of scoring for each product by the goods display assistance system according to the second example embodiment.

FIG. 12 is an explanatory diagram illustrating an example in which the goods display scores are output in order of goods display scores.

FIG. 13 is a flowchart illustrating an operation example of goods display scoring by the goods display assistance system according to the second example embodiment.

FIG. 14 is an explanatory diagram illustrating a modification of the goods display when two customers are shopping together.

FIG. 15 is an explanatory diagram illustrating a hardware configuration example of a computer.

### EXAMPLE EMBODIMENT

Hereinafter, example embodiments of a goods display assistance system, a goods display assistance method, a program, and a non-transitory recording medium recording the program according to the present disclosure will be described in detail with reference to the drawings. The present example embodiment does not limit the disclosed technology. In the following description, the head mounted display is abbreviated as an HMD.

### First Example Embodiment

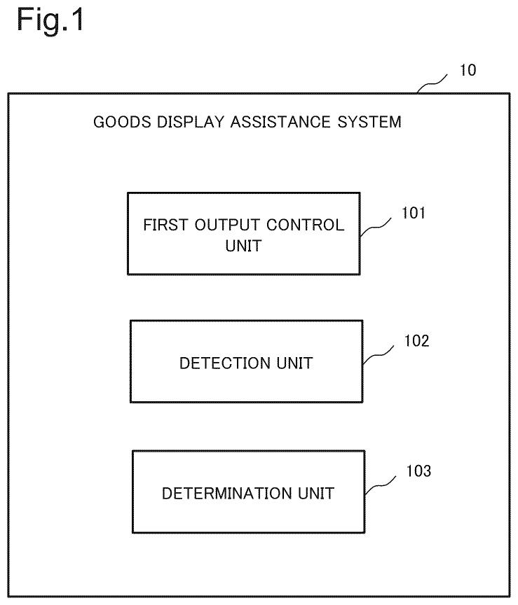

First, in the first example embodiment, a basic function of the goods display assistance system will be described. FIG. 1 is a block diagram illustrating a configuration example of a goods display assistance system according to a first example embodiment. A goods display assistance system 10 includes a first output control unit 101, a detection unit 102, and a determination unit 103.

The first output control unit 101 displays a predetermined goods display in the store in the virtual space on the HMD worn by the user. The store in the virtual space may be a store in which a store in the real space is reproduced, or may be a store used in a virtual space that does not exist in the real space. Alternatively, the user may be a customer, a store clerk, or a user who cooperates in an experiment for determining a goods display, and is not particularly limited.

The store in the virtual space may be, for example, a store such as a supermarket, a supermarket center, a convenience store, a mass merchandise store, a home center, a drug store, a store that handles apparel products, or an individual store such as a bakery or a daily dish store, and is not particularly limited.

The detection unit 102 detects a movement of the line of sight of the user. Specifically, the detection unit 102 may detect the line of sight of the user by the HMD and acquire the line of sight of the user from the HMD.

The determination unit 103 determines a new goods display based on the detected movement of the line of sight. The timing at which the determination unit 103 determines a new goods display is not particularly limited. For example, this timing may be a timing when the transaction is ended, or may be any timing during the current transaction.

For example, the determination unit 103 may determine a new goods display in which at least one of a type of a shelf, a color of the shelf, a size of the shelf, the number of stages of the shelf, a goods display position of a product displayed on the shelf, lighting on at least one of the shelf and the product, an advertisement material of the product, and decoration of the product is changed. An example in which the determination unit 103 determines a new goods display based a movement of the line of sight is not particularly limited, and will be described in detail in the second example embodiment.

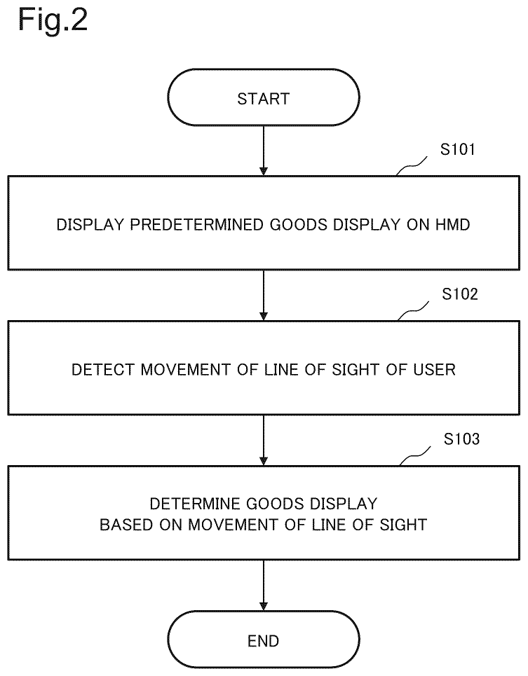

FIG. 2 is a flowchart illustrating an operation example of the goods display assistance system 10 according to the first example embodiment. The first output control unit 101 displays the goods display on the HMD (step S101). The detection unit 102 detects the movement of the line of sight of the user (step S102). The determination unit 103 determines the new goods display based a movement of the line of sight (step S103) and terminates the process.

It takes time and effort to change the goods display of the product in the store in the real space. In shopping in the virtual space, it may be difficult to determine how to display products. As described above, in the first example embodiment, the goods display assistance system 10 displays a goods display on the HMD, and determines a new goods display based a movement of the line of sight of the user. As a result, it is possible to try the goods display in the store in the real space in the virtual space, and it is possible to confirm the goods display according to the customer's preference or interest by the movement of the line of sight.

Alternatively, in shopping in the virtual space, the goods display can be easily changed to a goods display according to the customer's preference or interest by the movement of the line of sight. Therefore, it is possible to facilitate determination of the goods display. In the case of the AR space, there is a case where the shape of the shelf such as the size of the shelf cannot be changed, but in the case of the virtual space, the shape of the shelf and the like can be changed.

### Second Example Embodiment

Next, the second example embodiment will be described in detail with reference to the drawings. In the second example embodiment, an example of the goods display will be specifically described. In the second example embodiment, an example is described in which a customer will be described as the user. Hereinafter, description of content overlapping with the above description will be omitted to the extent that the description of the second example embodiment is not unclear.

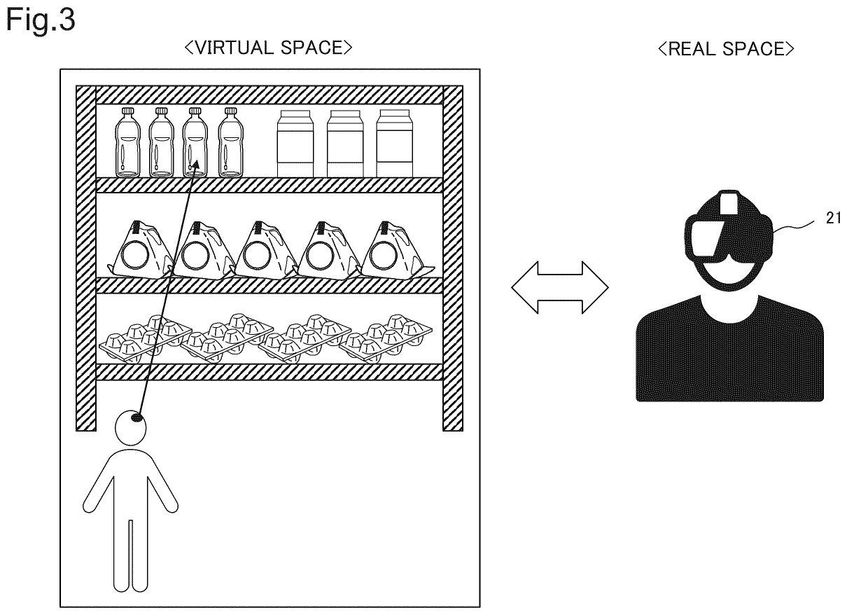

FIG. 3 is an explanatory diagram illustrating an example of a real space and a virtual space. In the real space, the customer wears an HMD 21. In the virtual space displayed on the HMD 21, a goods display in which products are disposed on shelves is displayed. An avatar of a customer is displayed in the virtual space. The avatar of the customer may or may not be displayed. The avatar of the customer may be similar to or different from the body of the customer in real space.

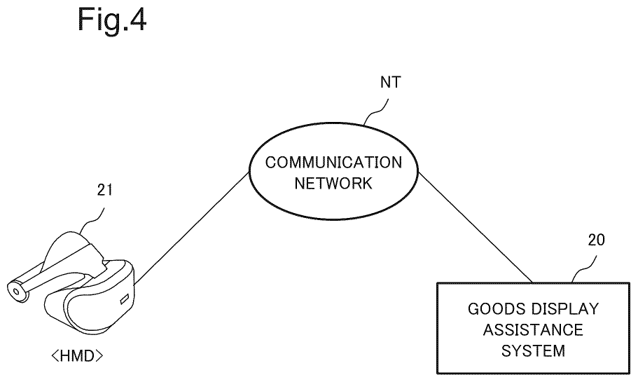

FIG. 4 is an explanatory diagram illustrating an example of connection between the goods display assistance system and the HMD 21. The goods display assistance system 20 is connected to the HMD 21 via a communication network. The HMD 21 has, for example, a function capable of detecting a line of sight of a customer wearing the HMD 21. For example, the HMD 21 may include a sensor capable of detecting a line of sight.

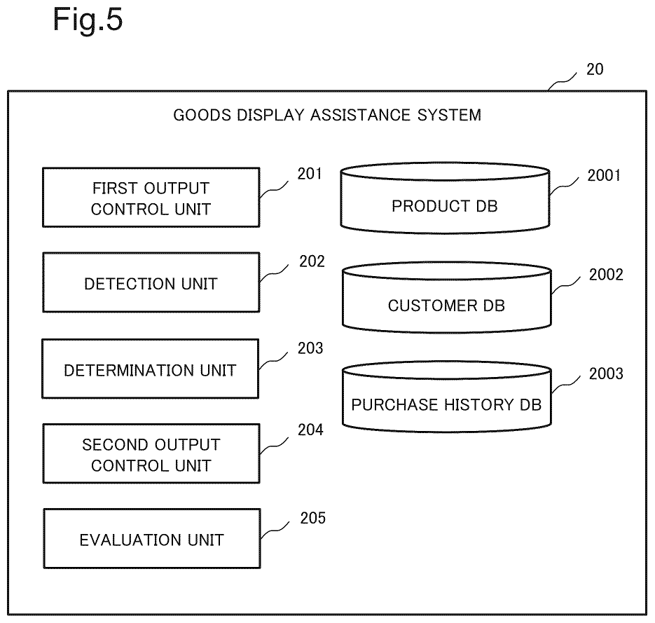

FIG. 5 is a block diagram illustrating a configuration example of a goods display assistance system 20 according to the second example embodiment. The goods display assistance system 20 includes a first output control unit 201, a detection unit 202, a determination unit 203, a second output control unit 204, and an evaluation unit 205.

The goods display assistance system 20 according to the second example embodiment is different from the system according to the first example embodiment in that the second output control unit 204 and evaluation unit 205 are included. The first output control unit 201 has the function of the first output control unit 101 according to the first example embodiment as a basic function. The detection unit 202 has the function of the detection unit 102 according to the first example embodiment as a basic function. The determination unit 203 has the function of the determination unit 103 according to the first example embodiment as a basic function.

The first output control unit 201 has a function of controlling display of the HMD 21. On the other hand, the second output control unit 204 has a function of presenting various types of information to a store clerk, an operator of the store, or the like.

The goods display assistance system 20 includes a product DB 2001, a customer DB 2002, and a purchase history DB 2003.

The product DB 2001 stores product information for each product displayed in a store in the virtual space, for example. The product information includes a product name, a product price, a product shape, a product classification, and the like. The classification of products is used, for example, when similar products are identified, and is not particularly limited as long as similarity can be identified.

The customer DB 2002 stores, for example, physical information about a customer in the virtual space. The physical information is, for example, information such as height. The physical information about the customer in the virtual space may be similar to or different from the physical information about the customer in the real space. Specifically, for example, the customer DB 2002 stores customer identification information for identifying a customer and physical information about the customer.

Alternatively, the customer DB 2002 stores, for example, attribute information about a customer in the virtual space. The attribute information is, for example, information about a customer other than the physical information, and is a gender, an age, a family structure, and the like, but not particularly limited thereto. Specifically, for example, the customer DB 2002 stores customer identification information for identifying a customer and an attribute of the customer.

The purchase history DB 2003 stores, for example, a purchase history of each customer in the store in the virtual space. Specifically, for example, the purchase history DB 2003 stores customer identification information and a purchase history in association with each other for each transaction. The purchase history DB 2003 may further store customer identification information, a purchase history, and a goods display at the time of transaction in association with each other. The purchase history DB 2003 may further store sales in association with each other. As a result, the goods display assistance system 20 can identify sales in each goods display.

Next, each functional unit will be described.

### Example of Repeated Display

The first output control unit 201 displays a predetermined goods display in the store in the virtual space on the HMD 21. The store in the virtual space may be a store in which a real store is reproduced or a store used in the virtual space. The predetermined goods display may be a goods display determined according to a purchase history of a customer, or may be a predetermined goods display determined by a store clerk. Alternatively, the predetermined goods display may be a goods display determined in the past or a goods display determined for another customer in the past, and is not particularly limited.

The detection unit 202 detects the movement of the line of sight of the customer wearing the HMD 21. Specifically, the detection unit 202 may cause the HMD 21 to detect the line of sight of the customer and acquire the line of sight of the customer from the HMD 21. For example, the method by which the HMD 21 detects the line of sight of the customer is not particularly limited as long as a known method is used.

Next, the determination unit 203 determines a new goods display based on the detected movement of the line of sight. The timing at which the determination unit 203 determines a new goods display is not particularly limited as described in the first example embodiment. As described in the first example embodiment, the determination unit 203 may change the shelf, may change the number of stages of the shelf, may change the goods display position of the product on the shelf, or may change the product displayed on the shelf as a new goods display, and is not particularly limited. The goods display determined by the determination unit 203 may be different from the predetermined goods display or may be the same as the predetermined goods display. For example, it may be identified that predetermined goods display is good based a movement of the line of sight of the customer. For example, the determination unit 203 may determine an optimal goods display for the customer based a movement of the line of sight from a plurality of goods displays determined in the past.

The first output control unit 201 displays a new goods display on the HMD 21. The timing at which the new goods display is displayed on the HMD 21 is not particularly limited. For example, the timing may be a timing of the next shopping by the customer or a timing of the current shopping. This timing may be determined according to the timing at which the goods display is determined by the determination unit 203.

For example, the first output control unit 201 may display the determined goods display on the HMD 21 of another customer who has newly started shopping. As a result, the goods display is appropriately repeated.

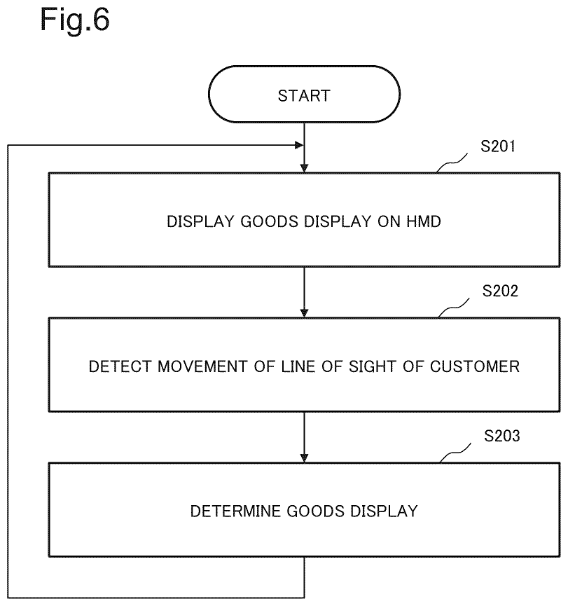

FIG. 6 is a flowchart illustrating an example in which the goods display is repeatedly displayed to the same customer by the goods display assistance system 20 according to the second example embodiment. The first output control unit 201 displays the goods display on the HMD 21 (step S201). The detection unit 202 detects the movement of the line of sight of the customer (step S202). The determination unit 203 determines a new goods display based a movement of the line of sight (step S203), and returns the process to step S201. As a result, the first output control unit 201 can display the determined goods display on the HMD 21. The detection unit 202 detects the movement of the line of sight of the customer in the determined goods display. Furthermore, the determination unit 203 determines the new goods display based a movement of the line of sight.

In this manner, these processes are appropriately repeated as necessary.

### Example of Scoring for Each Product

Next, in the goods display displayed, scoring may be performed for each product. The expression format of the score is not particularly limited as long as it is possible to identify good or bad. In the following description examples, it is assumed that scores are represented by numerical values, and the higher a score is for a product, the more attention the product receives from a customer.

For example, the evaluation unit 205 performs scoring for each product in the goods display based on the detected movement of the line of sight. The determination unit 203 determines a new goods display based on the score of each product.

The evaluation unit 205 may perform scoring based on the time during which the line of sight is directed to each product. When the time during with the line of sight of the customer is directed is long, the product may be a product that the customer pays attention to. For example, the product that the customer pays attention to may be a product that the customer is interested in or a product that the customer prefers to. On the other hand, when the time during which the line of sight of the customer is directed is short, the product may be a product that the customer does not pay attention to.

Therefore, specifically, for example, the evaluation unit 205 identifies the time during which the line of sight is directed to each product based a movement of the line of sight. This time is any of a time during which the line of sight is directed to the product once, a cumulative value of times during which the line of sight is directed to the product within a predetermined period, statistics thereof, and the like, and is not particularly limited. The evaluation unit 205 may perform scoring in such a way that the longer a time during which the line of sight is directed to a product is, the higher the score is for the product. The determination as to whether the time during which the line of sight is directed is long may be an absolute comparison or a relative comparison. For example, the evaluation unit 205 may perform scoring in such a way that the product to which a line of sight is directed for a predetermined time or more has a high score. Alternatively, the evaluation unit 205 may perform scoring in such a way that products with a predetermined number or more have a higher score in descending order of the time during which the line of sight is directed.

The evaluation unit 205 may perform scoring based on the number of times the line of sight is directed to each product based a movement of the line of sight. When the number of times the line of sight of the customer is directed is large, the product may be a product that the customer pays attention to. On the other hand, when the number of times the line of sight of the customer is directed is small, the product may be a product that the customer does not pay attention to. For example, the number of times may be the number of times the line of sight is directed for a predetermined time or more. More specifically, for example, the number of times is the number of times the line of sight is directed to the product continuously for 0.5 seconds or more.

Specifically, for example, the evaluation unit 205 identifies the number of times the line of sight is directed to a product among the products in the good display based a movement of the line of sight. The evaluation unit 205 may perform scoring in such a way that the larger the number of times the line of sight is directed to a product is, the higher the score is for the product. The determination as to whether the number of times the line of sight is directed is large may be an absolute comparison or a relative comparison. For example, the evaluation unit 205 may perform scoring in such a way that the product to which a line of sight is directed a predetermined number of times or more has a higher score. Alternatively, the evaluation unit 205 may perform scoring in such a way that products with a predetermined number or more has a higher the score in descending order of the number of times the line of sight is directed.

For example, the evaluation unit 205 may perform scoring based on a time from when a customer enters a store to when a line of sight is directed in the goods display. More specifically, this time may be a time from when the customer enters the store to when the line of sight is first directed. For example, when this time is short, the product may be a product that the customer pays attention to. On the other hand, when this time is long, the product may be a product that the customer does not pay attention to. The fact that the line of sight is directed here may mean that the line of sight is directed for a predetermined time or more.

Therefore, based a movement of the line of sight, the evaluation unit 205 identifies the time from when the customer enters the store to when the line of sight is first directed to each product. The evaluation unit 205 performs scoring based on the identified time. Specifically, for example, the evaluation unit 205 may perform scoring in such a way that the shorter the identified time is for product, the higher the score is for the product. The determination as to whether the time is short may be an absolute comparison or a relative comparison. For example, the evaluation unit 205 may perform scoring in such a way that a product in which the time is less than a predetermined time has a higher score. Alternatively, the evaluation unit 205 may perform scoring in such a way that products with a predetermined number or more have a higher score in ascending order of the time. The present disclosure is not limited to when the customer enters the store, and various changes can be made such as the time from when the customer turns the corner of the shelf to when the line of sight is first directed.

The method of identifying a product that the customer pays attention to or a product that the customer does not pay attention to is not limited to an example in which the time during which the line of sight is directed, the number of times the line of sight is directed, the time from when the customer enters the store to when the line of sight is first directed, the number of times the line of sight returns after the line of sight is once deviated, and the like are used as long as the feature amount that can be identified by the movement of the line of sight of the customer is used. For example, in a case where the line of sight returns after the line of sight is once deviated, for example, it is predicted that the customer cannot make up his/her mind about whether to purchase. It is predicted that the customer pays more attention to the product as the number of times the line of sight returns after the line of sight is once deviated increases. The number of times the line of sight returns may be included in the number of times the line of sight is directed. The scoring method may be any scoring method as long as the scoring is performed based on the feature amount of the movement of the line of sight that can be identified by the line of sight of the customer.

The methods of performing scoring by the evaluation unit 205 may be combined. For example, the evaluation unit 205 may perform scoring in such a way that the larger the number of times the line of sight is directed to a product is and the longer the time during which the line of sight is directed to the product is, the higher the score is for the product. The determination unit 203 may perform scoring in such a way that the smaller the number of times the line of sight is directed to a product is and the shorter the time during which the line of sight is directed to the product is, the lower the score is for the product.

Next, for example, the determination unit 203 determines a new goods display based on the score.

For example, the determination unit 203 may determine the goods display disposed at a position at which the product is easy for a customer to see in descending order of scores. Specifically, for example, the determination unit 203 identifies a predetermined number of products in descending order of scores. The determination unit 203 may determine a new goods display based on the identified products. Specifically, for example, the determination unit 203 may determine the goods display of the identified product as a product to be displayed. Alternatively, more specifically, for example, the determination unit 203 may determine the goods display in which the identified products are disposed at a position at which the product is easy for the customer to see. The position at which the product is easy for the customer to see may be a predetermined specific position or is not particularly limited. Alternatively, more specifically, for example, the determination unit 203 may determine a goods display in which an advertisement material of the identified product is placed. As a result, it is possible to change the goods display in such a way that the product that the customer pays attention to is more paid attention or easily seen.

For example, the determination unit 203 may determine the goods display in which products are disposed at positions at which the products are easy for customers to see in ascending order of scores. Specifically, for example, the determination unit 203 identifies a predetermined number of products in ascending order of scores. An example in which the determination unit 203 determines a new goods display based on the identified product may be the same as an example in descending order of scores, and a detailed description thereof will be omitted. As a result, it is possible to change the goods display in such a way that the product that the customer does not pay attention to can be more paid attention or easily seen.

In this manner, the determination unit 203 can determine a new goods display based on a product that the customer pays attention to or a product that the customer does not pay attention to.

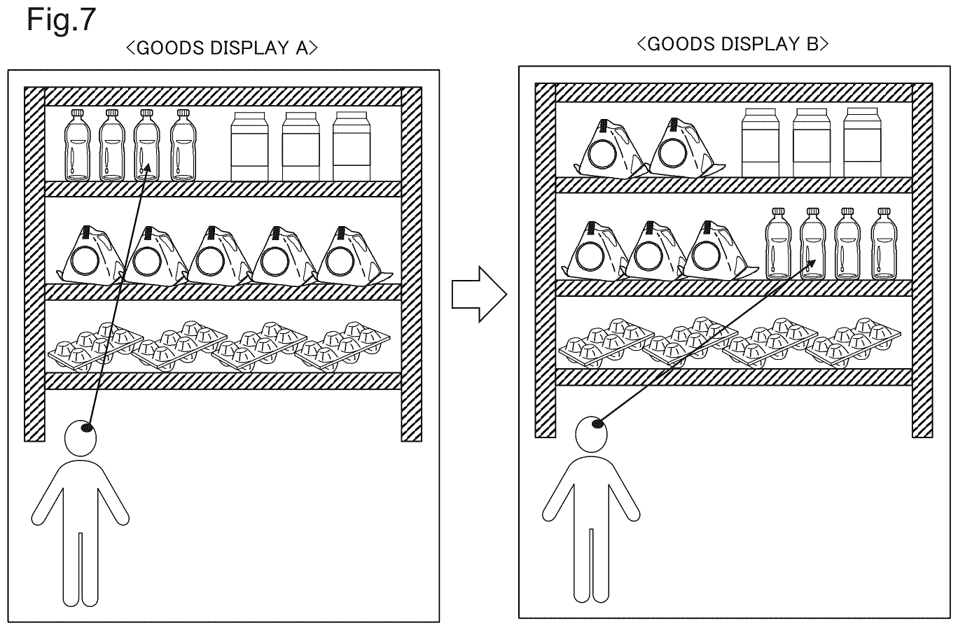

FIG. 7 is an explanatory diagram illustrating Example 1 in which a product attracting attention is moved to an easily seen position. The first output control unit 201 displays a goods display A on the HMD 21. The detection unit 202 tracks the movement of the line of sight of the customer by detecting the line of sight of the customer. At this time, it is assumed that a PET bottle beverage attracts attention. That is, it is assumed that the evaluation unit 205 gives a PET bottle beverage the highest score.

Therefore, the determination unit 203 determines a goods display B in such a way that a plastic bottle beverage is placed at an easily seen position. In FIG. 7, it is assumed that a position easily seen by the customer is the center of the shelf. Therefore, in FIG. 7, the determination unit 203 determines the goods display B in which the PET bottle beverage is moved from the uppermost stage of the shelf to the central stage of the shelf. The first output control unit 201 displays the determined goods display B on the HMD 21. In FIG. 7, in the goods display B from the goods display A, the products displayed on the shelf are not changed, but the goods display positions of the products on the shelf are changed.

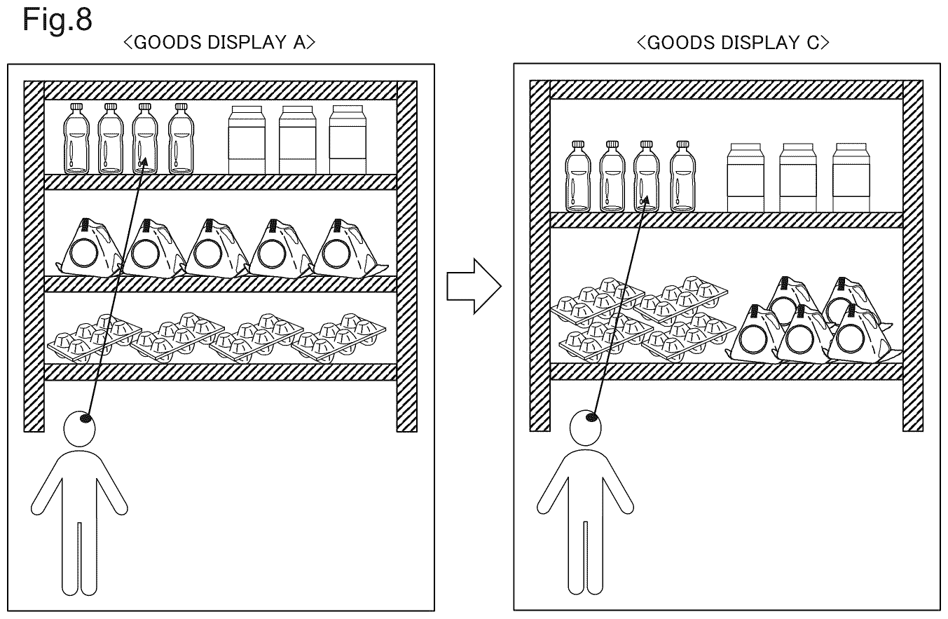

FIG. 8 is an explanatory diagram illustrating Example 2 in which a product attracting attention is moved to an easily seen position. The first output control unit 201 displays a goods display A on the HMD 21. The detection unit 202 tracks the movement of the line of sight of the customer by detecting the line of sight of the customer. At this time, it is assumed that a PET bottle beverage attracts attention. That is, it is assumed that the evaluation unit 205 gives a PET bottle beverage the highest score.

Therefore, the determination unit 203 determines a goods display C in such a way that a plastic bottle beverage is placed at an easily seen position. In FIG. 8, in the goods display C from the goods display A, the products displayed on the shelf are not changed, but the number of stages of the shelf is changed in such a way that the plastic bottle beverage is placed at an easily seen position. Therefore, the products displayed on the central stage in the goods display A are displayed on the lower stage in the goods display C.

Returning to the description of FIG. 5, as a method by which the determination unit 203 determines the goods display based on the score, for example, the determination unit 203 may determine a new goods display in which the products are disposed based on order of scores. As an example of determining the goods display in order of scores, the determination unit 203 may be a goods display in which products are disposed in order of scores. The goods display may be determined in such a way that customer evenly pays attention to various products displayed on the shelf. The goods display may be a goods display in which products having high scores and products having low scores are alternately disposed, and is not particularly limited. That is, the determination unit 203 determines the goods display in which a product that the customer pays attention to and a product that the customer does not pay attention to are close to each other.

Instead of the product that the customer pays attention to, the determination unit 203 may determine a new goods display with a product similar to the product as a product to be displayed based on the product DB 2001.

As another method by which the determination unit 203 determines the goods display, the determination unit 203 may determine a new goods display based on the purchase history. Specifically, for example, the determination unit 203 may determine a new goods display based on the score and the purchase history. More specifically, the determination unit 203 identifies a product to be purchased together with a product attracting attention having a high score from the purchase history. Analysis of simultaneous purchase is not particularly limited as long as existing technology is used. The determination unit 203 determines a goods display in which a product attracting attention and a product purchased together with the product are brought close to each other.

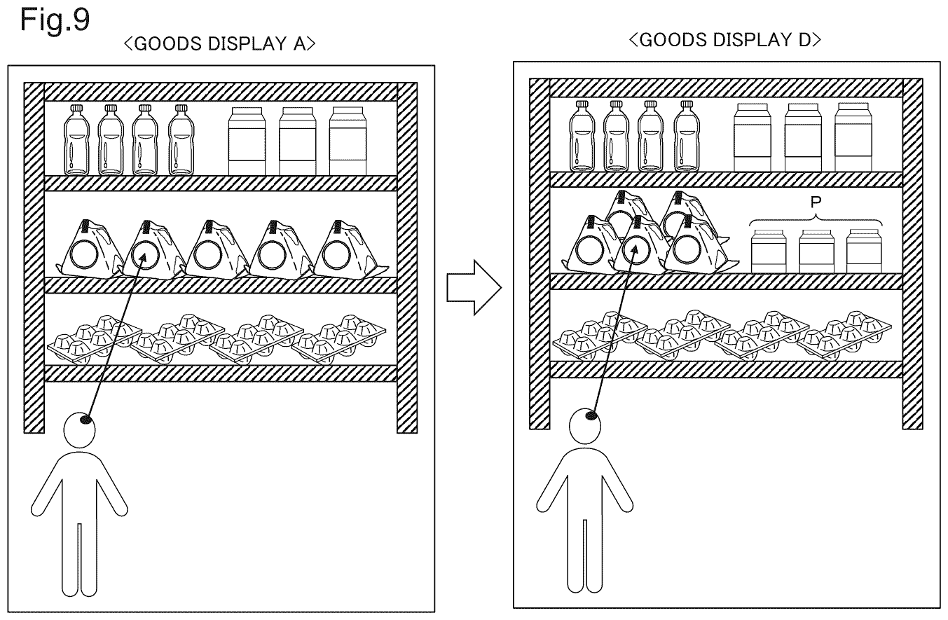

FIG. 9 is an explanatory diagram illustrating a goods display example in which a product to be purchased together with a product attracting attention is disposed next to the product attracting attention. The first output control unit 201 displays a goods display A on the HMD 21. The detection unit 202 tracks the movement of the line of sight of the customer by detecting the line of sight of the customer. At this time, it is assumed that a rice ball attracts attention. That is, it is assumed that the evaluation unit 205 performs scoring in such a way that the score of the rice ball is high. The determination unit 203 determines a goods display D in which the product P to be purchased together with the rice ball is disposed next to the rice ball. In FIG. 9, in the goods display D from the goods display A, the new product P is disposed next to the rice ball.

Returning to the description of FIG. 5, the second output control unit 204 may output the score of the product. The output method may be display on a display device or sound output to a sound output device. The timing of outputting the score of the product is not particularly limited. The second output control unit 204 may output the score each time the display of each goods display ends, or may output the score after the display of a plurality of goods displays ends.

For example, the second output control unit 204 may output the scores of the products in order of the scores of the products. For example, in a case where the score of the product is calculated for each goods display, the second output control unit 204 may output the score of the product for each goods display. As a result, the operator of the store or the like can check the attention level of the product in the virtual space.

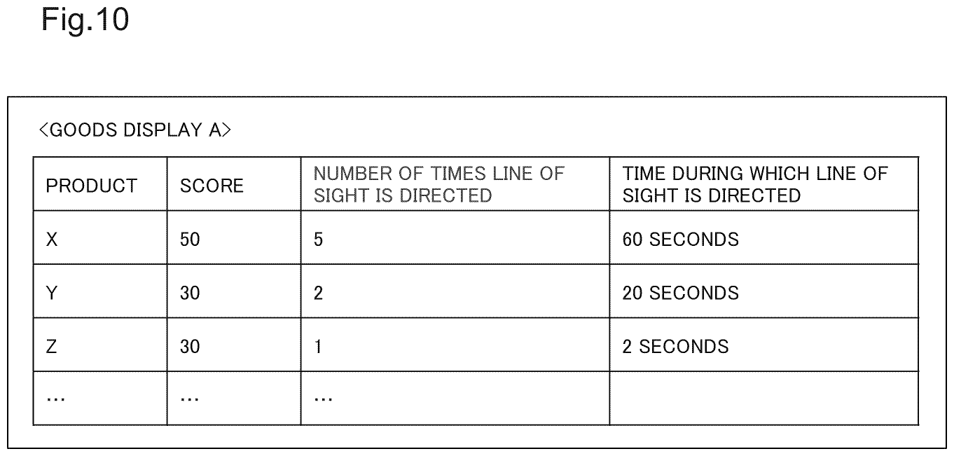

FIG. 10 is an explanatory diagram illustrating an example in which product scores are output in descending order of product scores. In FIG. 10, the second output control unit 204 displays, on the display device, the product name, the score of the product, and the feature amount related to the movement of the line of sight of the customer used for calculating the score of the product in association with each other. The display device may be provided in a terminal device operable by a store clerk or an operator of the store. In FIG. 10, the product names are disposed in descending order of scores. For example, in FIG. 10, the time during which the line of sight is directed and the number of times the line of sight is directed are displayed as the feature amounts related to the movement of the line of sight.

For example, the store clerk or the operator of the store may check whether the goods display is good or bad based on the score of the product.

A table as illustrated in FIG. 10 may be stored in a storage unit or the like. Alternatively, the evaluation unit 205 may perform scoring while creating such a table.

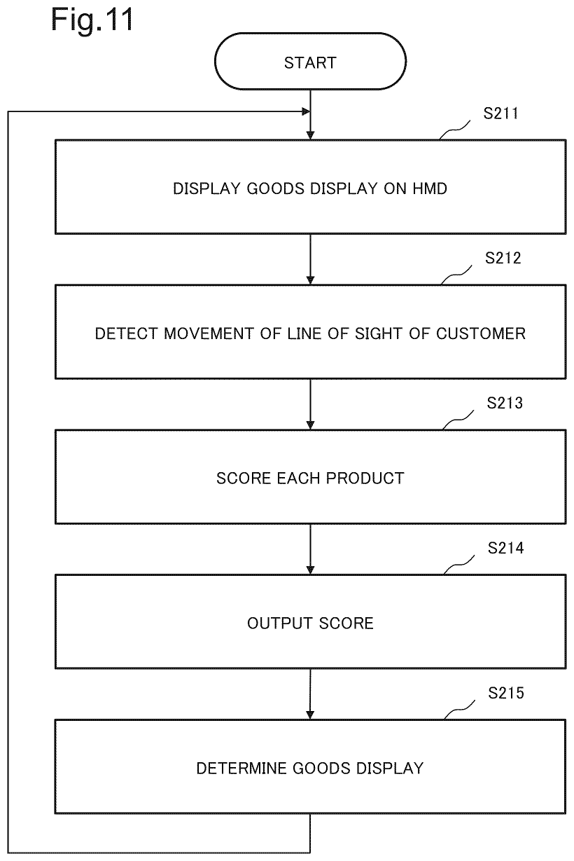

FIG. 11 is a flowchart illustrating an operation example of scoring for each product by the goods display assistance system 20 according to the second example embodiment. An example in which the goods display is repeatedly displayed will be described.

The first output control unit 201 displays the goods display on the HMD 21 (step S211). The detection unit 202 detects the movement of the line of sight of the customer (step S212).

Next, the evaluation unit 205 scores each product (step S213). The second output control unit 204 outputs the score of each product (step S214). The determination unit 203 determines a new goods display based on the score of each product (step S215), and returns the process to step S211. In this manner, these processes may be appropriately repeated as necessary. For example, in FIG. 11, the second output control unit 204 may not output the score.

In the above description, an example in which the evaluation unit 205 scores each product and the determination unit 203 determines a new goods display based on the score is an example and is not particularly limited.

For example, the determination unit 203 may determine a new goods display based on a product attracting attention without performing scoring. For example, the determination unit 203 determines a new goods display based on the time during which the line of sight is directed to each product in the goods display. As a result, a product that the customer pays attention to, a product that the customer does not pay attention to, and the like are identified based on the time during which the line of sight is directed to each product in the goods display, and a new goods display is determined by these products. For example, the determination unit 203 determines a new goods display based on a product to which a line of sight is directed for a predetermined time or more. Alternatively, for example, the determination unit 203 determines a new goods display based on a predetermined number of products in descending order of time during which the line of sight is directed among a plurality of products that can be displayed.

The determination unit 203 determines a new goods display based on the number of times the line of sight is directed to each product in the goods display. As a result, a product that the customer pays attention to, a product that the customer does not pay attention to, and the like are identified based on the number of times the line of sight is directed to each product in the goods display, and the goods display is determined by these products. For example, the determination unit 203 determines a new goods display based on a product in which the number of times the line of sight is directed is a predetermined number of times or more. Alternatively, for example, the determination unit 203 determines a new goods display based on a predetermined number of products in descending order of the number of times the line of sight is directed among the plurality of products that can be displayed.

The determination unit 203 determines a new goods display based on the time from the entry to the store to when the line of sight is first directed to each product in the goods display. As a result, a product that the customer pays attention to, a product that the customer does not pay attention to, or the like is identified based on the time from the entry to the store to when the line of sight is first directed to each product in the goods display. The goods display is determined by the product. For example, the determination unit 203 determines a new goods display based on a product in which the time is less than a predetermined time. Alternatively, for example, the determination unit 203 determines a new goods display based on a predetermined number of products in ascending order of time among a plurality of products that can be displayed.

As described above, an example in which a new goods display is determined based on a product that the customer pays attention to or a product that the customer does not pay attention to may be determined as in an example in which a goods display is determined based on the score, and a detailed description thereof will be omitted.

A method of determining a more detailed goods display may be the same as the method of determining the goods display based on the score, and a detailed description thereof will be omitted.

### Example of Scoring Each Goods Display

The evaluation unit 205 scores the goods display based a movement of the line of sight. The expression format of the score is not particularly limited as long as it is possible to identify good or bad. In the following description examples, scores are represented by numerical values, and a higher score indicates a better goods display. The second output control unit 204 may present the score of the goods display. As a method of presenting the score of the goods display, the second output control unit 204 may display the score on a display device or may cause a sound output device to output the score by voice. The display device and the sound output device may be provided in a terminal device that can be operated by the store clerk or the operator of the store.

Specifically, for example, the evaluation unit 205 identifies the time during which the line of sight is directed to each product in the goods display based a movement of the line of sight. The evaluation unit 205 may score the goods display based on the time during which the line of sight is directed to each product. More specifically, for example, the evaluation unit 205 may score the goods display in such a way that the longer the time during which the line of sight is directed to a predetermined product is, the higher the score is. The predetermined product may be, for example, a product that the store wants to sell, such as a bargain product, a product with low sales, or a product with a large stock quantity, and is not particularly limited. Alternatively, the evaluation unit 205 may score the goods display in such a way that the goods display in which the times during which the line of sight is directed to respective products are dispersed in a plurality of products has a higher score.

The evaluation unit 205 identifies the number of times the line of sight is directed to each product in the goods display based a movement of the line of sight. The evaluation unit 205 may score the goods display based on the number of times the line of sight is directed to each product. More specifically, for example, the evaluation unit 205 scores the goods display in such a way that the larger the number of times the line of sight is directed to a predetermined product is, the higher the score is. Alternatively, the evaluation unit 205 may score the goods display in such a way that the goods display in which the number of times the line of sight is directed to each product is dispersed in a plurality of products has a higher score.

The evaluation unit 205 identifies the movement amount of the line of sight in the goods display based a movement of the line of sight. The evaluation unit 205 may score the goods display based a movement amount. More specifically, for example, the evaluation unit 205 scores the goods display in such a way that the larger the movement amount is, the higher the score is.

The evaluation unit 205 may further score the goods display based on sales in the goods display identified by the purchase history DB 2003. For example, the evaluation unit 205 may score the goods display in such a way that the higher the sales are, the higher the score is. For example, the evaluation unit 205 may score the goods display in such a way that the larger the movement amount of the line of sight is and the higher the sales are, the higher the score is.

The scoring method described above is an example, and is not particularly limited. For example, the evaluation unit 205 may perform setting in such a way that the shorter a time during which the line of sight is directed to a predetermined product is, the higher the score is. As a usage example, the predetermined product may be a product that is not appropriate to show according to the age of the customer, and the evaluation unit 205 may perform setting in such a way that the shorter a time during which the line of sight is directed to the predetermined product according to the age of the customer is, the higher the score is. As described above, the scoring method can be variously changed.

The determination unit 203 may determine a new goods display based on the score of the goods display. For example, the determination unit 203 may determine a new goods display from a plurality of goods displays based on the score of the goods display.

The evaluation unit 205 may score each of a plurality of goods displays. The second output control unit 204 presents a plurality of goods displays in order of scores of the plurality of goods displays. As a method of presenting a plurality of goods displays, the second output control unit 204 may display a plurality of goods displays on a display device or may cause a sound output device to output a plurality of goods displays by voice. For example, the second output control unit 204 may present a predetermined number of goods displays in order of scores of a plurality of goods displays.

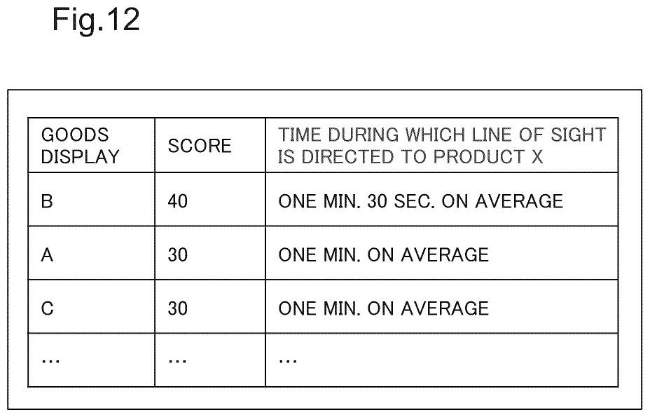

FIG. 12 is an explanatory diagram illustrating an example in which the goods display scores are output in order of scores of the goods display. An example in which the goods display is determined in such a way that the longer the time during which the line of sight is directed to the product X is, the higher the score is will be described. In FIG. 12, the second output control unit 204 displays, on the display device, the goods display score and the feature amount regarding the movement of the line of sight of the customer used for calculating the score of the goods display in association with each other in order of scores of the goods display. This feature amount is the time during which the line of sight is directed to the product X.

Although not illustrated, in a case where a plurality of different feature amounts is used, a plurality of different feature amounts may be displayed. Although not illustrated, a goods display picture or the like may be displayed for each goods display.

For example, the store clerk or the operator of the store may check whether each goods display is good or bad by referring to the score of the goods display. The store clerk or the operator of the store may select the goods display to be used in the store in the real space by referring to the score of the goods display.

The second output control unit 204 may present a goods display candidate in a store in the real space based on the goods display score. As a method of presenting a goods display candidate, the second output control unit 204 may display a plurality of goods displays on a display device, or may cause a sound output device to output a plurality of goods displays by voice. More specifically, for example, the second output control unit 204 may present a predetermined number of goods displays a having high score among a plurality of goods displays as goods display candidates in a store in the real space.

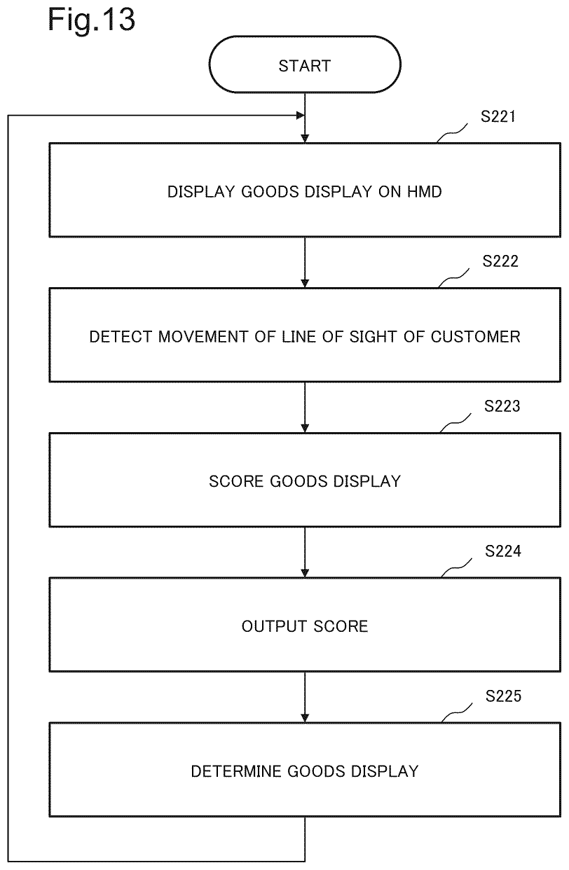

FIG. 13 is a flowchart illustrating an operation example of the goods display scoring by the goods display assistance system 20 according to the second example embodiment. An example in which the goods display is repeatedly displayed will be described.

The first output control unit 201 displays the goods display on the HMD 21 (step S221). The detection unit 202 detects the movement of the line of sight of the customer (step S222).

Next, the evaluation unit 205 scores the goods display (step S223). The second output control unit 204 outputs the score (step S224). The determination unit 203 determines a new goods display based on the score of each product (step S225), and returns the process to step S211. In this manner, these processes may be appropriately repeated as necessary. For example, since the scores of the past goods display are accumulated by repetition, a better goods display is determined.

The timing repeated here is not limited to an example in which the timing is dynamically repeated during one shopping by the same user. For example, the goods display determined at the next time of shopping may be displayed.

The evaluation unit 205 may not score the goods display based a movement of the line of sight in the goods display, but the determination unit 203 may determine a new goods display based a movement amount of the line of sight identified from the movement of the line of sight in the goods display.

The scoring for each goods display and the scoring for each product may be combined. The determination unit 203 may determine a new goods display based on the score of each goods display and the score of each product in each goods display.

The determination unit 203 may determine a new goods display without scoring the goods display. For example, the determination unit 203 may determine a new goods display based a movement amount of the line of sight in the goods display. Specifically, for example, the determination unit 203 may determine a goods display with a large movement amount of the line of sight, a goods display with a small movement amount of the line of sight, a goods display with an average movement amount, or the like as a new goods display from a plurality of goods displays displayed in the past. For example, the determination unit 203 may determine, as a new goods display, a goods display in which the time during which the line of sight is directed to a predetermined product is long or a goods display in which the time during which the line of sight is directed to a predetermined product is short from a plurality of goods displays. As described above, the method of determining the length of time is not particularly limited. For example, the determination unit 203 may determine a goods display in which the number of times the line of sight is directed to a predetermined product is large or a goods display in which the number of times the line of sight is directed to a predetermined product is small from a plurality of goods displays as a new goods display. As described above, the method of determining the number of times is not particularly limited.

### Unit of Customer

Each example described above may be performed on a customer basis or may be performed on a plurality of customers basis.

### Personalization First, an example performed on a customer basis will be described. The determination unit 203 determines a new goods display on a customer basis.

Alternatively, for example, the evaluation unit 205 analyzes a product that the customer pays attention to based on a movement of the line of sight of the customer on a customer basis. Alternatively, the evaluation unit 205 scores each product on a customer basis.

Alternatively, the evaluation unit 205 scores each goods display on a customer basis. The determination unit 203 may determine a new goods display on a customer basis based on the result by the evaluation unit 205.

As a result, it is possible to personalize the goods display. For example, this is particularly useful in a case where a customer dynamically changes the goods display in a store in a virtual space.

### A Plurality of Customers Basis

First, an example in which scoring is performed on a plurality of customers basis will be described. The plurality of customers may be a plurality of customers who shop together or a plurality of customers who shop at different timings. Whether a plurality of customers is shopping together may be estimated from a conversation or the like, or may be estimated by the same shopping basket or the like being used.

The determination unit 203 may determine a new goods display based movements of the lines of sight of a plurality of customers on a plurality of customers basis. Specifically, for example, the determination unit 203 may determine the goods display in which a product that a plurality of customers pays attention to is disposed at a position where the plurality of customers can easily see.

Alternatively, the evaluation unit 205 analyzes a product that a plurality of customers pays attention to based movements of the lines of sight of the plurality of customers on a plurality of customers basis. A plurality of customers may identify a product to which the customers pay attention to.

For example, in a case where a plurality of customers is shopping together, the evaluation unit 205 may identify a product to which a plurality of customers directs the line of sight at the same timing as a product that the plurality of customers pays attention to.

Alternatively, the evaluation unit 205 scores each product on a plurality of customers basis. Alternatively, the evaluation unit 205 scores each goods display on a plurality of customers basis.

Thus, the goods display can be determined on a plurality of customers basis. For example, it is useful in a case where a plurality of customers shops together in a virtual space. Alternatively, for example, in a case where there is a store in the real space, it is useful for determining the goods display of the store in the real space.

### Display Goods Display Different Between Some Customers and Remaining Customers

The first output control unit 201 displays a predetermined goods display on the head mounted display worn by each of some customers among the plurality of customers, and displays a goods display different from the predetermined goods display on the head mounted display worn by each of the remaining customers among the plurality of customers.

The detection unit 202 detects a movement of a line of sight of each of a plurality of customers.

The determination unit 203 determines a new goods display based the movement of the line of sight of each of the plurality of customers. For example, the determination unit 203 may determine a new goods display, for example, from a predetermined goods display and a goods display different from the predetermined goods display.

As described above, the goods display assistance system 20 may display different effective displays for a plurality of customers, and an experiment may be performed in order to determine the goods display of the store in the real space. Although the plurality of customers is divided into two groups such as some customers and the remaining customers, the plurality of customers may be divided into three or more groups, and how to divide the plurality of customers into groups is not particularly limited. For example, the goods display assistance system 20 may display different displays for respective customers to perform an experiment.

### Example Using Physical Information

For each example described above, a new goods display may be determined or scoring may be performed using the physical information.

The determination unit 203 may determine a new goods display based on physical information. For example, the position identified by the physical information in the virtual space may be an easily seen position. Specifically, for example, the determination unit 203 may determine a new goods display by setting a position identified by the physical information in the virtual space as a position at which the product is easy for the customer to see. In combination with the above-described example, the determination unit 203 may determine a new goods display in which a product attracting attention is moved to a position at which the product is easy for a customer to see. The position identified by the physical information is, for example, an easily seen position with the height of the customer in the virtual space. For example, an easily seen position may be determined in advance for each height, and an easily seen position may be identified for the height of the customer in the virtual space.

In a case where a new goods display is determined on a plurality of customers basis, for example, the determination unit 203 may determine the new goods display by setting a position identified by the physical information about each of the plurality of customers as a position that the plurality of customers can easily see.

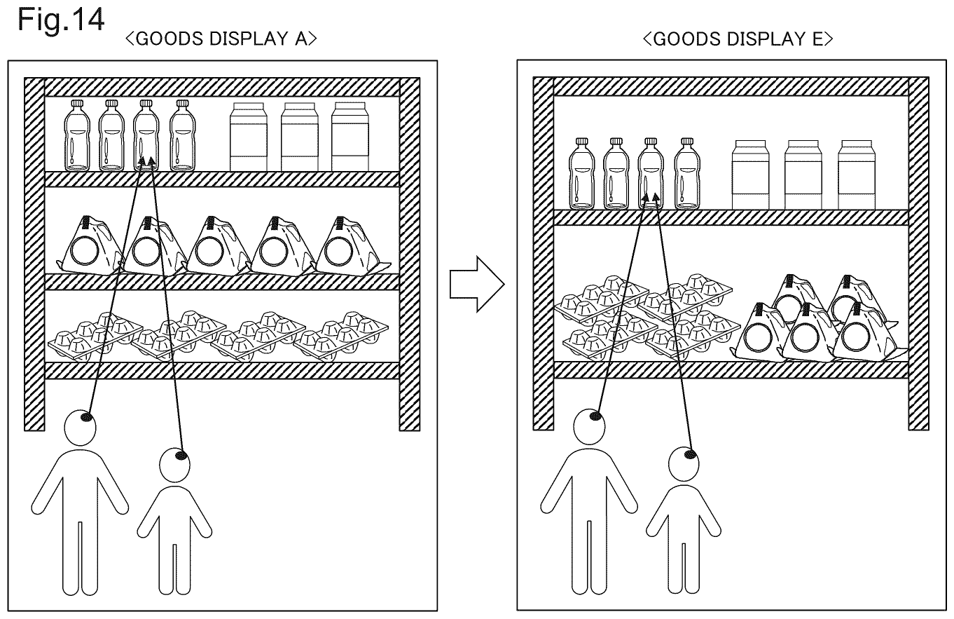

FIG. 14 is an explanatory diagram illustrating a modification of the goods display when two customers are shopping together. It is assumed that there is a height difference between the two customers.

For example, the first output control unit 201 displays the goods display A on the HMD 21 worn by each of the two customers. The detection unit 202 detects the movement of the line of sight of the two customers. The evaluation unit 205 identifies a plastic bottle beverage as a product that the two customers pay attention to based movements of the lines of sight of the two customers.

The determination unit 203 identifies a position where the two people can easily see based on the physical information about the two people. Specifically, for example, the determination unit 203 may identify a position where the two people can easily see from the statistics of the heights of the two people. The statistics of the heights of the two persons is an average value of the heights of the two persons. In the case of three or more people, the height statistics may be a mode value, a median value, or the like.

The determination unit 203 determines a goods display E in which the position of the plastic bottle beverage is lower than that in the goods display A because the number of stages of the shelf is reduced and the position of the uppermost stage is lowered in such a way that the plastic bottle beverage is placed at the identified position. The first output control unit 201 displays the goods display E on the HMD 21 worn by each of the two customers. Accordingly, the goods display is dynamically changed.

Returning to the description of the evaluation unit 205, the evaluation unit 205 may perform scoring in consideration of physical information such as the height of the customer in the virtual space. Specifically, the evaluation unit 205 may score each product for each height. Alternatively, the evaluation unit 205 may score each goods display for each height of the customer.

For example, the first output control unit 201 may use a goods display determined by a customer having physical information similar to that of the new customer as a predetermined goods display to be displayed on the HMD 21 of the new customer. Instead of the physical information, a goods display determined by a customer having similar attribute information may be used as the predetermined goods display.

Instead of the physical information, attribute information about the customer such as a gender and an age may be used. For example, the evaluation unit 205 may score each product for each age or each age generation. For example, the evaluation unit 205 may score each product for each gender. For example, the evaluation unit 205 may score the goods display for each age or each age generation. For example, the evaluation unit 205 may score the goods display for each gender. The predetermined product described above may be determined for each age, each age generation, and each gender.

### Specific Example

In order to facilitate understanding, some specific examples will be given based on the above description.

### First Specific Example

The evaluation unit 205 analyzes a product that the customer pays attention to while the customer is shopping at the store in the virtual space. The determination unit 203 may determine a goods display including a shelf in which products that the customer pays attention to are collected. The first output control unit 201 displays a goods display including a shelf in which products that the customer pays attention to are collected. The timing at which the first output control unit 201 displays the goods display is not particularly limited. For example, this timing may be a timing before the customer leaves the store, such as when the customer approaches the exit. Alternatively, the timing at which the goods display is displayed may be a timing after going around the selling area of the store in the virtual space. The timing at which the goods display is displayed may be a timing at which a predetermined time or more has elapsed from the entry to the store. The timing at which the goods display is displayed may be a timing immediately before the customer makes payment. The timing at which the goods display is displayed may be a timing at which the customer turns the corner of the passage of the store in the virtual space. The timing immediately before the customer makes payment may be a timing at which the customer approaches the payment device, a timing at which the customer transmits a payment instruction, or the like, and is not particularly limited.

For example, the first output control unit 201 may display a product that the customer pays attention to and a shelf of a product similar to the product after the customer looks around the store and makes a round. As a result, it is possible to select a product to be actually purchased when going around the store again from the product that the customer would like to obtain.

### Second Specific Example

The evaluation unit 205 analyzes a product that the customer pays attention to while the customer is shopping at the store in the virtual space. For example, the determination unit 203 may determine a goods display including lighting that highlights a product that the customer pays attention to. The first output control unit 201 displays the determined goods display on the HMD 21.

### Third Specific Example

The evaluation unit 205 analyzes a product that the customer pays attention to while the customer is shopping at the store in the virtual space. The determination unit 203 may set a goods display in which the size of the product information about the product of interest is larger than the size of the product information about other products. The first output control unit 201 displays the determined goods display on the HMD 21.

### Fourth Specific Example

The evaluation unit 205 analyzes a product that the customer pays attention to while the customer is shopping at the store in the virtual space. For example, when the number of goods displays of products on that the customer pays attention to is less than a predetermined number, the determination unit 203 may determine goods displays whose number is increased according to the number of stocks of the product that the customer pays attention to. That is, the determination unit 203 may determine the number of goods displays of each on the shelf based a movement of the line of sight.

### Fifth Specific Example

For example, in a case where a plurality of customers shops together at a store in the virtual space, the evaluation unit 205 may analyze a product that some of the plurality of customers pay attention to. The determination unit 203 may determine a goods display that causes another customer to recognize a product that some of the customers pay attention to. The goods display that the another customer recognizes may be an emphasized goods display. The first output control unit 201 displays the determined goods display on the HMD 21 of each of the plurality of customers. The emphasized goods display is not particularly limited, and for example, an advertisement material or the like may be disposed, illumination around a product may be turned on, or the product may be surrounded by a frame or the like and emphasized.

Alternatively, the first output control unit 201 displays the determined goods display on the HMD 21 worn by a customer who does not pay attention to the product among the plurality of customers.

The specific examples described above are some examples, and can be variously changed and combined, or may be other examples based on the above description.

As described above, in the second example embodiment, the goods display assistance system 20 displays a goods display on the HMD 21, and determines a new goods display based a movement of the line of sight of the customer. As a result, it is possible to try a goods display in an actual store in the virtual space. Alternatively, in shopping in the virtual space, the goods display can be easily changed to a goods display according to the customer's preference or interest by the movement of the line of sight. Therefore, it is possible to facilitate determination of the goods display.

The goods display assistance system 20 determines a new goods display in which at least one of the color of the shelf, the shape of the shelf such as the size of the shelf, the number of stages of the shelf, the type of the shelf, the goods display position of the product on the shelf, the arrangement order of the product on the shelf, the product displayed on the shelf, the number of goods displays of the product displayed on the shelf, the lighting on the shelf, the lighting on the product displayed on the shelf, the advertisement material of the product, the decoration of the product, and the like is changed. It is further preferable that the goods display can be set in the virtual space and can be easily changed. In this way, it is possible to facilitate determination of various goods displays.

The goods display assistance system 20 displays the determined goods display on the HMD 21. As a result, the goods display assistance system 20 can repeatedly display the goods display. For example, the goods display assistance system 20 can dynamically and repeatedly display the goods display according to customer's preference or interest. For example, a new goods display may be dynamically and repeatedly displayed during shopping by a customer, and it is possible to easily change the goods display that cannot be easily performed in a real space. Therefore, it is possible to provide a shopping experience that cannot be easily performed in the real space.

The goods display assistance system 20 may display the determined goods display on the HMD 21 worn by a customer different from the customer. As a result, the determined goods display can be applied to another customer. For example, the goods display assistance system 20 may display the goods display on the HMD 21 worn by a customer having at least one of physical information and attribute information similar to that of the customer. For example, the goods display assistance system 20 can display a goods display that is easy for customers to see to another customer having similar physical information.

The goods display assistance system 20 presents the determined goods display as a goods display candidate in a store in the real space.

As a result, it is possible to facilitate determination of the goods display of a store in the real space.

The goods display assistance system 20 determines a new goods display based on the time during which the line of sight is directed to each product in the goods display. As a result, a product that the customer pays attention to, a product that the customer does not pay attention to, and the like are identified based on the time during which the line of sight is directed to each product in the goods display, and a new goods display is determined by these products. For example, the goods display assistance system 20 determines a new goods display based on a product to which a line of sight is directed for a predetermined time or more. Alternatively, for example, the goods display assistance system 20 determines a new goods display based on a predetermined number of products in descending order of time during which the line of sight is directed among a plurality of products that can be displayed. As a result, in shopping in the virtual space, it is possible to confirm, easily try, or dynamically display the goods display according to the customer's preference or interest by the movement of the line of sight.

The goods display assistance system 20 determines a new goods display based on the number of times the line of sight is directed to each product in the goods display. As a result, a product that the customer pays attention to, a product that the customer does not pay attention to, and the like is identified based on the number of times the line of sight is directed to each product in the goods display, and a new goods display is determined by the product. For example, the goods display assistance system 20 determines a new goods display based on a product to which the line of sight is directed a predetermined number of times or more. Alternatively, for example, the goods display assistance system 20 determines a new goods display based on a predetermined number of products in descending order of the number of times the line of sight is directed among a plurality of products that can be displayed. As a result, in shopping in the virtual space, it is possible to confirm, easily try, or dynamically display the goods display according to the customer's preference or interest by the movement of the line of sight.

The goods display assistance system 20 determines a new goods display based on the time from the entry to the store to when the line of sight is first directed to each product in the goods display. As a result, a product that the customer pays attention to, a product that the customer does not pay attention to, or the like is identified based on the time from the entry to the store to when the line of sight is first directed to each The goods display is determined by the product in the goods display. product. For example, the goods display assistance system 20 determines a new goods display based on a product in which the time is less than a predetermined time. Alternatively, for example, the goods display assistance system 20 determines a new goods display based on a predetermined number of products in ascending order of time among a plurality of products that can be displayed. As a result, in shopping in the virtual space, it is possible to confirm, easily try, or dynamically display the goods display according to the customer's preference or interest by the movement of the line of sight.

The goods display assistance system 20 scores each product in the goods display based on the detected movement of the line of sight, and determines a new goods display based on the score of each product. For example, as a scoring method, the goods display assistance system 20 performs scoring in such a way that the shorter the time from when the customer enters the store in the virtual space to when the line of sight of the product is directed to a product among products displayed in the virtual space based a movement of the line of sight is, the lower the score is for the product. Alternatively, the goods display assistance system 20 performs scoring in such a way that the longer the time during which the line of sight is directed to a product among products in the goods display in the virtual space based a movement of the line of sight is, the higher the score is for the product. According to these, scoring can be performed in such a way that the more attention a product receives from a customer, the higher the score is for the product.

The goods display assistance system 20 scores the goods display based a movement of the line of sight to output the score of the goods display. In a case where there is a plurality of goods displays, the goods display assistance system 20 scores each of the plurality of goods displays and presents the plurality of goods displays in order of scores of the plurality of goods displays. In more detail, the goods display assistance system 20 identifies the time during which the line of sight is directed to each product in the goods display based a movement of the line of sight, and scores the goods display based on the time during which the line of sight is directed.

As an example of the scoring of the goods display according to the time when the line of sight is directed, the goods display assistance system 20 scores the goods display in such a way that the longer the time during which the line of sight is directed to a predetermined product among the products displayed in the virtual space is, the higher the score is. As a result, it is possible to give a better evaluation to a goods display in which a product desired to be sold by a store attracts more attention.

As another example of the goods display scoring, the goods display assistance system 20 identifies the number of times a line of sight is directed to each product in the goods display based a movement of the line of sight, and scores the goods display based on the identified number of times.

As an example of the scoring of the goods display by the number of times the line of sight is directed, the goods display assistance system 20 scores the goods display in such a way that the larger the number of times the line of sight is directed to a predetermined product is, the higher the score is. As a result, it is possible to give a better evaluation to a goods display in which a product desired to be sold by a store attracts more attention.

The goods display assistance system 20 may present a goods display candidate in a store in the real space based on the goods display score. For example, the goods display assistance system 20 may present a goods display having a high score from a plurality of goods displays.

In the virtual space, the physical information may be different from or similar to the physical information about the customer in the real space. Therefore, the goods display assistance system 20 determines a new goods display based on the physical information about the customer in the virtual space.

The goods display assistance system 20 displays a predetermined goods display in the store in the virtual space on the HMD 21 worn by each of the plurality of customers, detects the movement of the line of sight of each of the plurality of customers, and determines a new goods display based movements of the lines of sight of the plurality of customers. That is, the goods display assistance system 20 displays the same display on the HMDs 21 of a plurality of customers, and analyzes the movements of the lines of sight of the plurality of customers. Alternatively, for example, a plurality of customers may be set as one group, and a new goods display may be determined based on the lines of sight of a plurality of customers included in one group. For example, it is possible to facilitate determination of the goods display when a plurality of customers visits a store together and search for a product.

The goods display assistance system 20 determines a new goods display based on the physical information about each of a plurality of customers in the virtual space. As a result, it is possible to facilitate determination of the goods display suitable for the physical information about the customer in the virtual space.

The goods display assistance system 20 may perform setting in such a way that the goods display displayed on the HMDs 21 worn by some customers among the plurality of customers may be different from the goods display displayed on the HMDs 21 worn by the remaining customers among the plurality of customers. As a result, the goods display assistance system 20 can analyze the movement of the line of sight of the customer in various goods displays.

The description of each example embodiment ends. Each example embodiment may be modified. Next, modifications will be described.

### First Modification

In each example embodiment, an example in which a new goods display is determined based a movement of the line of sight of the user wearing the HMD 21 is described, but the present disclosure is not limited thereto.

The detection unit 202 may detect a movement of the hand of the user in the virtual space. The determination unit 203 determines a new goods display based a movement of the hand of the user.

For example, the evaluation unit 205 may identify a product picked up by the user in the virtual space based a movement of the hand of the user. The evaluation unit 205 may identify a product picked up by the user in the virtual space as a product that the user pays attention to. The evaluation unit 205 may identify the number of times of picking up each product. For example, the evaluation unit 205 may identify the product as a product that the user pays attention to as the number of times of picking up the product is larger.

An example in which the determination unit 203 determines a new goods display based on a product attracting attention may be similar to an example in which a goods display is determined based on a product of interest identified based on a movement of a line of sight of the user, and a detailed description thereof will be omitted.

In the case of scoring a product, the evaluation unit 205 may score the product based on the number of times the user picks up the product. For example, the evaluation unit 205 scores a product in such a way that the larger the number of times the user picks up a product is, the higher the score is for the product.

In the case of scoring the goods display, the evaluation unit 205 may score the goods display based on the number of times the user picks up the product. For example, the evaluation unit 205 scores the goods display in such a way that the larger the number of times of picking up the predetermined product is, the higher the score is.

As described above, according to the first modification, as in the example of the movement of the line of sight of the user, it is possible to facilitate the determination of the goods display.

The first modification and each example embodiment may be combined. For example, the determination unit 203 may determine a new goods display with a product to which the line of sight is directed to for a long time and in which the number of times the line of sight is directed is large among products picked up by the user, as a product to which attention is paid.

### Second Modification

In the second modification, an example in which the determination unit 203 determines a new goods display based on whether the user has purchased a product in a store in the virtual space will be described.

The determination unit 203 determines a new goods display based on the product purchased by the user. For example, the determination unit 203 determines a new goods display based on a product purchased by the user among products that the user pays attention to.

The evaluation unit 205 may score the product based on the product purchased by the user. For example, the evaluation unit 205 scores a product in such a way that a product purchased by the user among products that the user pays attention to has a higher score.

The evaluation unit 205 may score the goods display based on the product purchased by the user. Specifically, for example, the evaluation unit 205 may score the goods display in such a way that the goods display from which the user purchases a predetermined product has a higher score.

### Third Modification

In each example embodiment, the goods display in the virtual space is described as an example, but the present disclosure is not limited to the virtual space and may be an AR space. For example, the determination unit 203 may determine the goods display in which the products in the virtual space are disposed on the shelf in the real space. As a result, it is possible to easily change and test the arrangement of the products on the shelf, the advertisement material of the product, the lighting on the product, and the like in the actual store.

### Fourth Modification

In each example embodiment, an example is described in which the detection unit 202 detects the movement of the line of sight of the user by causing the sensor provided in the HMD 21 to detect the line of sight of the user and acquiring the line of sight of the user from the HMD 21.

For example, the detection unit 202 may detect the movement of the gaze point as the movement of the line of sight of the user with the position identified by the movement of the face as the gaze point. For example, the detection unit 202 may detect the movement of the gaze point as the movement of the line of sight of the user with a position identified by whether the user moves the neck to face right or left as the gaze point.

Alternatively, for example, the detection unit 202 may detect the movement of the gaze point as the movement of the line of sight of the user with the center position included in the visual field as the gaze point. Alternatively, for example, the detection unit 202 may detect the movement of the gaze point as the movement of the line of sight of the user with the center position of the liquid crystal of the display device of the HMD 21 as the gaze point. That is, the detection unit 202 may detect the movement of the gaze point as the movement of the line of sight of the user, using the center position of the field of view, the center position of the visual field, the center position of the projection image, and the like as the gaze point. Each center position is an example, and a region that can be regarded as the center may be used as the center region, or a specific position selected from the region may be used as the gaze point. Alternatively, the detection unit 202 may switch which position is used as the gaze point by the user.

The description of each example embodiment and each modification is ended. Each example embodiment and each modification may be used in combination. For example, in each example embodiment, the goods display assistance system may include part of each functional unit and information.

Each example embodiment is not limited to the above-described example, and various modifications can be made. The configuration of the goods display assistance system in each example embodiment is not particularly limited. For example, the goods display assistance system may be achieved by one HMD, one terminal device, and one server.

Alternatively, the goods display assistance system may be achieved by different devices for respective functions or data. For example, the goods display assistance system may include a plurality of servers. For example, the goods display assistance system may be configured by a combination of an HMD and a server.

In each example embodiment, each piece of information may include part of the information described above. Each piece of information may include information other than the above-described information. Each piece of information may be divided into a plurality of tables or a plurality of pieces of information in more detail. As described above, a method of achieving each piece of information is not particularly limited.

Each screen displayed on the display device is an example, and is not particularly limited. In each screen, a button, a list, a checkbox, an information display field, an input field, and the like (not illustrated) may be added. The background color of the screen and the like may be changed.

For example, in each example embodiment, the process of generating information and the like of the screen to be displayed on the display device may be performed by the second output control unit of the goods display assistance system or may be performed by the display device.

### Hardware Configuration Example of Computer

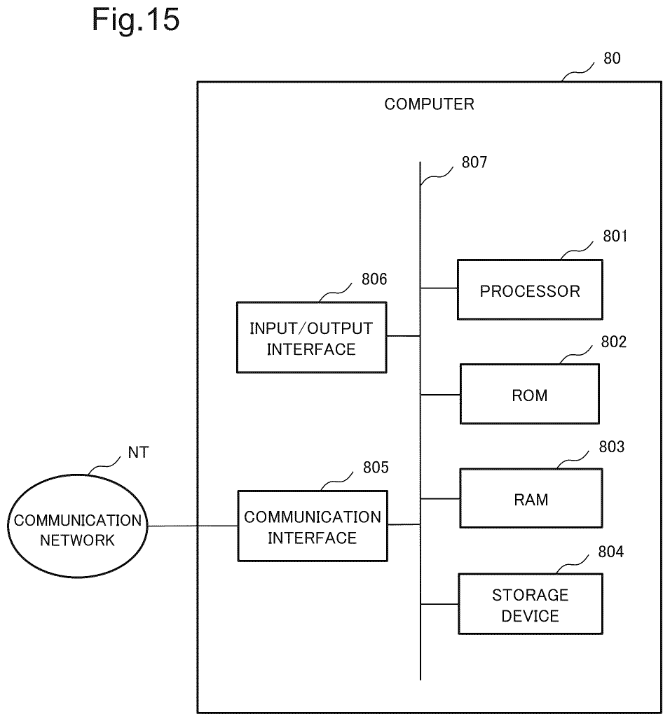

Next, a hardware configuration example in a case where each device such as the goods display assistance system and the terminal device described in each example embodiment is implemented by a computer will be described. FIG. 15 is an explanatory diagram illustrating a hardware configuration example of a computer. For example, some or all of the devices can be achieved by using an any combination of a computer 80 and the program as illustrated in FIG. 15, for example.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT.

The communication interface 805 manages an interface between the communication network NT and the inside of the computer 80. The communication interface 805 controls an input/output of data from the external device or the external computer 80.

The input/output interface 806 is connected to at least one of an input device, an output device, and an input/output device. The connection method may be wireless or wired. Examples of the input device include a keyboard, a mouse, and a microphone. Examples of the output device include a display device, a lighting device, and a speaker that outputs sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 15. The computer 80 may have components other than those illustrated in FIG. 15. For example, the computer 80 may include a drive device or the like.

The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a goods display. The computer 80 may include an input device, an output device, and an input/output device.

The computer 80 may include various sensors (not illustrated). The type of the sensor is not particularly limited. Examples of the sensor include an acceleration sensor, a gyro sensor, a magnetic sensor, a global positioning system (GPS), and a sensor. Examples of the sensor include a fingerprint sensor, light, detection and ranging (LiDAR), a proximity sensor, and an ambient optical sensor.

The description of the hardware configuration of each device ends. There are various modifications in a method of achieving each device. For example, each device may be achieved by an any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

When part or all of each component of each device is achieved by a plurality of computers, circuits, and the like, the plurality of computers, circuits, and the like may be disposed in a centralized manner or in a distributed manner.

The goods display assistance method described in each example embodiment is achieved by execution of the goods display assistance system. For example, the goods display assistance method is achieved by a computer such as a server or a terminal device executing a program prepared in advance. The program described in each example embodiment is recorded in a computer-readable recording medium such as an HDD, an SSD, a flexible disk, an optical disk, a flexible disk, a magnetic optical disk, or a USB memory. The program is executed by being read from the recording medium by the computer. The program may be distributed via the communication network NT.

Each component of the goods display assistance system in each example embodiment described above may be achieved in hardware as in a computer. Alternatively, each component may be achieved by a computer or firmware based on program control.

While the present disclosure has been particularly shown and described with reference to each of example embodiments, the present disclosure is not limited to these example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A goods display assistance system including
a first output control means for displaying a predetermined goods display in a store in a virtual space on a head mounted display worn by a user,
a detection means for detecting a movement of a line of sight of the user, and
a determination means for determining a new goods display based on the detected movement of the line of sight.

### Supplementary Note 2

The goods display assistance system according to Supplementary Note 1, wherein
the determination means determines a new goods display in which at least one of a type of a shelf, a color of the shelf, a size of the shelf, the number of stages of the shelf, a goods display position of a product displayed on the shelf, the product displayed on the shelf, lighting on at least one of the shelf and the product, an advertisement material of the product, and decoration for the product is changed.

### Supplementary Note 3

The goods display assistance system according to Supplementary Note 1 or 2, wherein
the first output control means displays the determined goods display on the head mounted display.

### Supplementary Note 4

The goods display assistance system according to Supplementary Note 1 or 2, wherein
the first output control means displays the determined goods display on a head mounted display worn by another user different from the user.

### Supplementary Note 5

The goods display assistance system according to Supplementary Note 4, wherein
the user and the another user have similar physical information in the virtual space.

### Supplementary Note 6

The goods display assistance system according to any one of Supplementary Notes 1 to 5, further including
a second output control means for presenting the determined goods display as a goods display candidate in a store in a real space.

### Supplementary Note 7

The goods display assistance system according to any one of Supplementary Notes 1 to 6, further including
an evaluation means for identifying a time during which the line of sight is directed to each product in the predetermined goods display based on the movement of the line of sight, wherein
the determination means determines a new goods display based on the identified time for each product.

### Supplementary Note 8

The goods display assistance system according to any one of Supplementary Notes 1 to 6, further including
an evaluation means for identifying the number of times the line of sight is directed to each product in the predetermined goods display based on the movement of the line of sight, wherein
the determination means determines a new goods display based on the identified number of times for each product.

### Supplementary Note 9

The goods display assistance system according to any one of Supplementary Notes 1 to 6, further including
an evaluation means for identifying a time from when the user enters a store to when the line of sight is directed to each product in the goods display based on the movement of the line of sight, wherein
the determination means determines a new goods display based on the identified time for each product.

### Supplementary Note 10

The goods display assistance system according to any one of Supplementary Notes 1 to 5, further including
an evaluation means for scoring each product in the goods display based on the detected movement of the line of sight, and
a second output control means for outputting a score of each product.

### Supplementary Note 11

The goods display assistance system according to Supplementary Note 10, wherein
the evaluation means performs scoring in such a way that the longer a time during which the line of sight is directed to a product among products in the goods display based on the movement of the line of sight is, the higher a score is for the product.

### Supplementary Note 12

The goods display assistance system according to Supplementary Note 10, wherein
the evaluation means performs scoring in such a way that the larger the number of times the line of sight is directed to a product among products in the goods display based on the movement of the line of sight is, the higher a score is for the product.

### Supplementary Note 13

The goods display assistance system according to Supplementary Note 10, wherein
the evaluation means performs scoring in such a way that the shorter a time from when the user enters the store to when the line of sight is directed to a product among products in the goods display based on the movement of the line of sight is, the higher a score is for the product.

### Supplementary Note 14

The goods display assistance system according to any one of Supplementary Notes 1 to 5, further including
an evaluation means for scoring the predetermined goods display based on the movement of the line of sight, and
a second output control means for outputting a score of the predetermined goods display.

### Supplementary Note 15

The goods display assistance system according to Supplementary Note 14, wherein
the evaluation means scores each of a plurality of goods displays, and
the second output control means presents the plurality of goods displays in order of scores of the plurality of goods displays.

### Supplementary Note 16

The goods display assistance system according to Supplementary Note 14 or 15, wherein
the evaluation means
identifies a time during which the line of sight is directed to each product in the goods display based the movement of the line of sight, and
scores the goods display based on the time during which the line of sight is directed.

### Supplementary Note 17

The goods display assistance system according to Supplementary Note 16, wherein
the evaluation means
scores the predetermined goods display in such a way that the longer the time during which the line of sight is directed to a predetermined product, the higher a score is.

### Supplementary Note 18

The goods display assistance system according to Supplementary Note 14, wherein
the evaluation means
identifies the number of times the line of sight is directed to each product in the goods display based the movement of the line of sight, and
scores the predetermined goods display based on the identified number of times.

### Supplementary Note 19

The goods display assistance system according to Supplementary Note 18, wherein
the evaluation means
scores the predetermined goods display in such a way that the larger the number of times the line of sight is directed to a predetermined product is, the higher a score is.

### Supplementary Note 20

The goods display assistance system according to any one of Supplementary Notes 14 to 19, wherein
the second output control means presents a goods display candidate in a store in a real space based on the score.

### Supplementary Note 21

The goods display assistance system according to any one of Supplementary Notes 1 to 20, wherein
the determination means determines a new goods display based on physical information about the user in the virtual space.

### Supplementary Note 22

The goods display assistance system according to any one of Supplementary Notes 1 to 20, wherein
the first output control means displays the predetermined goods display in the store in the virtual space on a head mounted display worn by each of a plurality of users,
the detection means detects a movement of a line of sight of each of the plurality of users, and
the determination means determines a new goods display based the movement of the line of sight of each of the plurality of users.

### Supplementary Note 23

The goods display assistance system according to Supplementary Note 22, wherein
the determination means determines a new goods display based on physical information about each of the plurality of users in the virtual space.

### Supplementary Note 24

The goods display assistance system according to any one of Supplementary Notes 1 to 21, wherein
the first output control means displays the predetermined goods display on a head mounted display worn by each of some users among a plurality of users, and displays a goods display different from the predetermined goods display on a head mounted display worn by each of remaining users among the plurality of users,
the detection means detects a movement of a line of sight of each of the plurality of users, and
the determination means determines a new goods display based the movement of the line of sight of each of the plurality of users.

### Supplementary Note 25

A goods display assistance method including
displaying a predetermined goods display in a store in a virtual space on a head mounted display worn by a user,
detecting a movement of a line of sight of the user, and
determining a new goods display based on the detected movement of the line of sight.

### Supplementary Note 26

A non-transitory computer-readable recording medium that records a program, the program causing a computer to execute the processes of
displaying a predetermined goods display in a store in a virtual space on a head mounted display worn by a user,
detecting a movement of a line of sight of the user, and
determining a new goods display based on the detected movement of the line of sight.

### Supplementary Note 27

A program causing a computer to execute the processes of
displaying a predetermined goods display in a store in a virtual space on a head mounted display worn by a user,
detecting a movement of a line of sight of the user, and
determining a new goods display based on the detected movement of the line of sight.

### REFERENCE SIGNS LIST

10, 20 goods display assistance system
21 HMD
101, 201 first output control unit
102, 202 detection unit
103, 203 determination unit
204 second output control unit
205 evaluation unit
80 computer
801 processor
802 ROM
803 RAM
804 storage device
805 communication interface
806 input/output interface
807 bus
NT communication network
A, B, C, D, E goods display
2001 product DB
2002 customer DB
2003 purchase history DB

What is claimed is:

1. A goods display assistance system comprising:
at least one memory storing instructions; and
at least one processor configured to execute the instructions to:
display a predetermined goods display in a store in a virtual space on a head mounted display worn by a user;
detect a movement of a line of sight of the user; and
determine a new goods display based on the detected movement of the line of sight.

2. The goods display assistance system according to claim 1, wherein the at least one processor is further configured to execute the instructions to:
determine a new goods display in which at least one of a type of a shelf, a color of the shelf, a size of the shelf, the number of stages of the shelf, a goods display position of a product displayed on the shelf, the product displayed on the shelf, lighting on at least one of the shelf and the product, an advertisement material of the product, and decoration for at least one of the shelf and the product is changed.

3. The goods display assistance system according to claim 1, wherein the at least one processor is further configured to execute the instructions to:
display the determined goods display on the head mounted display.

4. The goods display assistance system according to claim 1, wherein the at least one processor is further configured to execute the instructions to:
display the determined goods display on a head mounted display worn by another user different from the user.

5. The goods display assistance system according to claim 4, wherein
the user and the another user have similar physical information in the virtual space.

6. The goods display assistance system according to claim 1, the at least one processor is further configured to execute the instructions to:
output the determined goods display as a goods display candidate in a store in a real space.

7. The goods display assistance system according to claim 1, the at least one processor is further configured to execute the instructions to:
identify a time during which the line of sight is directed to each product in the predetermined goods display based on the movement of the line of sight, wherein
determine a new goods display based on the identified time for each product.

8. The goods display assistance system according to claim 1, the at least one processor is further configured to execute the instructions to:
identify the number of times the line of sight is directed to each product in the predetermined goods display based on the movement of the line of sight, wherein
determine a new goods display based on the identified number of times for each product.

9. The goods display assistance system according to claim 1, the at least one processor is further configured to execute the instructions to:
identify a time from when the user enters a store to when the line of sight is directed to each product in the goods display based on the movement of the line of sight, wherein
determine a new goods display based on the identified time for each product.

10. The goods display assistance system according to claim 1, the at least one processor is further configured to execute the instructions to:
score each product in the goods display based on the detected movement of the line of sight; and
output a score of each product.

11. The goods display assistance system according to claim 10, wherein the at least one processor is further configured to execute the instructions to:
perform scoring in such a way that the longer a time during which the line of sight is directed to a product among products in the goods display based on the movement of the line of sight is, the higher a score is for the product.

12. The goods display assistance system according to claim 10, wherein the at least one processor is further configured to execute the instructions to:
perform scoring in such a way that the larger the number of times the line of sight is directed to a product among products in the goods display based on the movement of the line of sight is, the higher a score is for the product.

13. The goods display assistance system according to claim 10, wherein the at least one processor is further configured to execute the instructions to:
perform scoring in such a way that the shorter a time from when the user enters the store to when the line of sight is directed to a product among products in the goods display based on the movement of the line of sight is, the higher a score is for the product.

14. The goods display assistance system according to claim 1, the at least one processor is further configured to execute the instructions to:
score the predetermined goods display based on the movement of the line of sight; and
output a score of the predetermined goods display.

15. The goods display assistance system according to claim 14, wherein the at least one processor is further configured to execute the instructions to:
score each of a plurality of goods displays, and
output the plurality of goods displays in order of scores of the plurality of goods displays.

16. The goods display assistance system according to claim 14, wherein the at least one processor is further configured to execute the instructions to:
identify a time during which the line of sight is directed to each product in the goods display based the movement of the line of sight, and
score the goods display based on the time during which the line of sight is directed.

17. The goods display assistance system according to claim 16, wherein the at least one processor is further configured to execute the instructions to: score the predetermined goods display in such a way that the longer the time during which the line of sight is directed to a predetermined product, the higher a score is.

18. The goods display assistance system according to claim 14, wherein the at least one processor is further configured to execute the instructions to:
identify the number of times the line of sight is directed to each product in the goods display based the movement of the line of sight, and
score the predetermined goods display based on the identified number of times.

19-24. (canceled)

25. A goods display assistance method comprising:
displaying a predetermined goods display in a store in a virtual space on a head mounted display worn by a user;
detecting a movement of a line of sight of the user; and
determining a new goods display based on the detected movement of the line of sight.

26. A non-transitory computer-readable recording medium that records a program, the program causing a computer to execute the processes of:
displaying a predetermined goods display in a store in a virtual space on a head mounted display worn by a user;
detecting a movement of a line of sight of the user; and
determining a new goods display based on the detected movement of the line of sight.
